(19) United States
(12) Patent Application Publication
(10) Pub. No.: US 2007/0177308 A1
(43) Pub. Date: Aug. 2, 2007

(54) Disk device

(75) Inventor: Akihiro Kimura, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/700,182

(22) Filed: Jan. 31, 2007

(30) Foreign Application Priority Data
Jan. 31, 2006 (JP) 2006-022985

(51) Int. Cl. G11B 5/48; G11B 5/54

(52) U.S. Cl. 360/245.9; 360/256

(57) ABSTRACT

According to one embodiment, a disk device includes a box-shaped case, which contains a disk-shaped recording medium, a drive motor which supports and rotates the recording medium, a head which performs information processing for the recording medium, and a head actuator which moves the head with respect to the recording medium. The disk device has a connection cable pulled out from the case onto an outer surface of the case, a control circuit board provided opposite the outer surface of the case, and a relay flexible printed circuit board which electrically connects the connection cable and the control circuit board.

### CROSS-REFERENCE TO RELATED APPLICATIONS

This application is based upon and claims the benefit of priority from Japanese Patent Application No. 2006-022985, filed Jan. 31, 2006, the entire contents of which are incorporated herein by reference.

### BACKGROUND

1. Field

An embodiment of this invention relates to a disk device having a disk as a recording medium.

2. Description of the Related Art

In recent years, disk devices, such as magnetic disk devices, optical disk devices, etc., have been widely used as external recording devices of computers or image recording devices.

A disk device, e.g., a magnetic disk device, generally comprises a case in the form of a rectangular box. The case contains a magnetic disk, spindle motor, magnetic heads, head actuator, voice coil motor, board unit, etc. The magnetic disk serves as a magnetic recording medium. The spindle motor serves as drive means that supports and rotates the disk. The magnetic heads write and read information to and from the disk. The head actuator supports the magnetic heads for movement with respect to the disk. The voice coil motor rocks and positions the head actuator. The board unit has a head IC and the like.

The spindle motor, the voice coil motor, and a printed circuit board for controlling the operation of the magnetic heads are screwed to the outer surface of the case through the board unit. An interface connector for connecting the magnetic disk device to another external device is soldered to an end portion of the printed circuit board.

The printed circuit board is mounted with stacking connectors, pressure connectors, etc. In the case, the board unit is provided with a connector and another connector that is connected to the spindle motor. As described in Jpn. Pat. Appln. KOKAI Publication No. 2003-22634, for example, these connectors are connected to the connectors on the printed circuit board through the case.

Modern magnetic disk devices are being made smaller and smaller so that they can be used as recording devices for a wider variety of electronic apparatuses, especially for smaller-sized electronic apparatuses. In magnetic disk devices that use disks with diameters of 1 inch or more, a printed circuit board that is lapped on a surface of a case can be made smaller in area than the case surface. In magnetic disk devices that use disks with diameters of less than 1 inch, however, the printed circuit board must be made smaller as the case is reduced in size. Therefore, an installation space over the printed circuit board is narrowed, so that it is difficult to mount a plurality of electronic components on the circuit board. Likewise, an installation space in the case is also narrowed, so that it is hard to mount a plurality of electronic components in the case. Since connectors that connect the components in the case and the printed circuit board are relatively tall and bulky, in particular, they are spatially restricted in design and constitute a hindrance to reductions in the thickness and size of the entire magnetic disk device including the circuit board.

If a plurality of connectors can be arranged in place, moreover, connector pins may possibly suffer a connection failure or come into contact with their adjacent pins, thus requiring an improvement in reliability. Further, the connectors themselves are expected to be miniaturized, so that it is hard to obtain a mechanism for maintaining the contact pressure, and the manufacturability is lowered to cause an increase in manufacturing costs.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing an HDD according to a first embodiment of the invention;

FIG. 2 is an exemplary exploded perspective view of the HDD;

FIG. 3 is an exemplary plan view showing a case and an internal structure of the HDD;

FIG. 4 is an exemplary exploded perspective view showing the control circuit board side of the HDD and FPCs for connection;

FIG. 5 is an exemplary perspective view showing the control circuit board side of the HDD;

FIG. 6 is an exemplary sectional view of the HDD taken along line VI-VI of FIG. 5; and

FIG. 7 is an exemplary sectional view of an HDD according to a second embodiment of the invention.

### DETAILED DESCRIPTION

An embodiment of this invention will now be described in detail with reference to the accompanying drawings. In general, according to one embodiment of the invention, a disk device comprises: a box-shaped case; a disk-shaped recording medium located in the case; a drive motor which is located in the case and supports and rotates the recording medium; a head which performs information processing for the recording medium; a head actuator which is provided in the case, supports the head for movement, and moves the head with respect to the recording medium; a connection cable pulled out from the case onto an outer surface of the case; a control circuit board provided opposite the outer surface of the case; and a relay flexible printed circuit board which electrically connects the connection cable and the control circuit board.

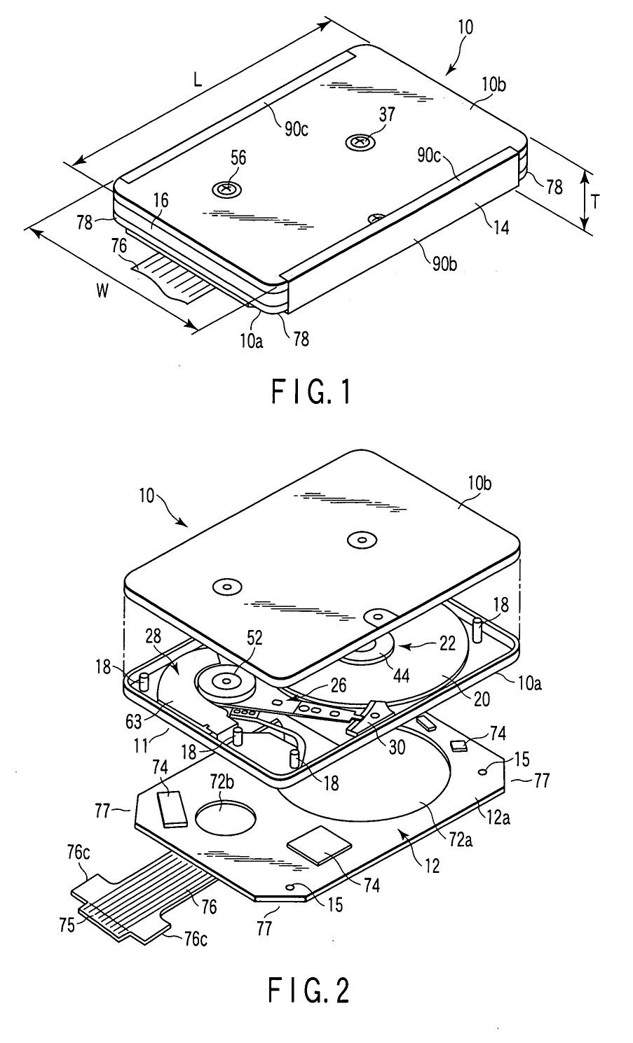

As shown in FIGS. 1 and 2, a hard disk drive (hereinafter referred to as an HDD) according to a first embodiment comprises a case 10 substantially in the form of a rectangular box that contains various members (mentioned later), a rectangular control circuit board 12 lapped on the outer surface of the case 10, and a bottom cover 14 attached to the case 10 so as to cover the circuit board 12. The case 10, circuit board 12, and bottom cover 14 each have a length L of 32 mm and a width W of 24 mm, for example, and a thickness T including these three elements ranges from 3 to 6 mm. The thickness T is adjusted to, for example, 3.3 or 5 mm, depending on the number of stored disks.

As shown in FIGS. 1 to 4, the case 10 has a first shell 10a and a second shell 10b that are substantially equal in size. Each of the first and second shells 10a and 10b is a substantially rectangular metallic structure with side walls set up on its peripheral edge portion. The first and second shells 10a and 10b are located opposite each other so that their respective peripheral edge portions face each other. A belt-shaped seal 16 is wound around the peripheral edge portions of the shells 10a and 10b, thereby connecting them and sealing a gap between them. Thus, the case 10 is constructed in the form of a rectangular box having a rectangular bottom wall 11, an upper wall, and four side walls that are set up on the periphery of the bottom wall.

The bottom wall 11 of the first shell 10a forms a rectangular outer surface. The four corners of the case 10 that include the corners of the bottom wall are rounded in a circular arc each. Thus, the seal 16 that is wound around the peripheral edge portion of the case 10 is prevented from being damaged by the corners of the case and from loosening to impair the airtightness.

In the case 10, support posts 18 are provided on the peripheral edge portion of the case. Each support post 18 has a proximal end that is fixed to the inner surface of the first shell 10a and is set substantially upright on the inner surface of the first shell. In the position of each support post 18, a threaded hole is formed in the bottom wall 11 and extends into the support post.

The case 10 contains a magnetic disk 20 about, e.g., 0.85 inches in diameter, spindle motor 22, magnetic head 24, carriage 26, voice coil motor (VCM) 28, ramp load mechanism 30, solenoid latch 32, board unit 34, etc. The magnetic disk 20 functions as an information recording medium. The spindle motor 22 serves as a drive motor that supports and rotates the disk. The magnetic head 24 writes and reads information to and from the disk. The carriage 26 supports the magnetic head for movement with respect to the disk 20. The VCM 28 rocks and positions the carriage. The ramp load mechanism 30 unloads into and holds the magnetic head in a position at a distance from the magnetic disk when the head is moved to the peripheral edge portion of the disk. The solenoid latch 32 holds the carriage in a retracted position. The board unit 34 has a head IC and the like. The spindle motor 22, carriage 26, and VCM 28 constitute a mechanical section.

The spindle motor 22 is mounted on the first shell 10a. The motor 22 has a pivot 36, which is fixed to and set substantially upright on the inner surface of the bottom wall 11 of the first shell 10a. An extended end of the pivot 36 is fastened to the second shell 10b by a fixing screw 37 that is externally threaded into the second shell. Thus, the pivot 36 is doubly supported by the first and second shells 10a and 10b.

A rotor is rotatably supported on the pivot 36 by a bearing (not shown). An end portion of the rotor on the side of the second shell 10b forms a circular columnar hub 43, and the magnetic disk 20 is coaxially fitted on the hub. An annular clamp ring 44 is fitted on an end portion of the hub 43 and holds the circumferential edge portion of the disk 20. Thus, the magnetic disk 20 is fixed to the rotor and supported for integral rotation with the rotor.

An annular permanent magnet (not shown) is fixed to an end portion of the rotor on the side of the first shell 10a and situated coaxially with the rotor. The spindle motor 22 has a stator core attached to the first shell 10a and coils wound around the stator core. The stator core and the coils are arranged with a gap therebetween outside the permanent magnet.

The carriage 26 that constitutes a head actuator is provided with a bearing assembly 52 that is fixed on the inner surface of the first shell 10a. The bearing assembly 52 has a pivot 53 set upright on the inner surface of the first shell 10a and a circular cylindrical hub 54 that is rotatably supported on the pivot 53 by a pair of bearings. An extended end of the pivot 53 is fastened to the second shell 10b by a fixing screw 56 that is externally threaded into the second shell. Thus, the pivot 53 is doubly supported by the first and second shells 10a and 10b. The bearing assembly 52 that serves as a bearing portion is located side by side with the spindle motor 22 in the longitudinal direction of the case 10.

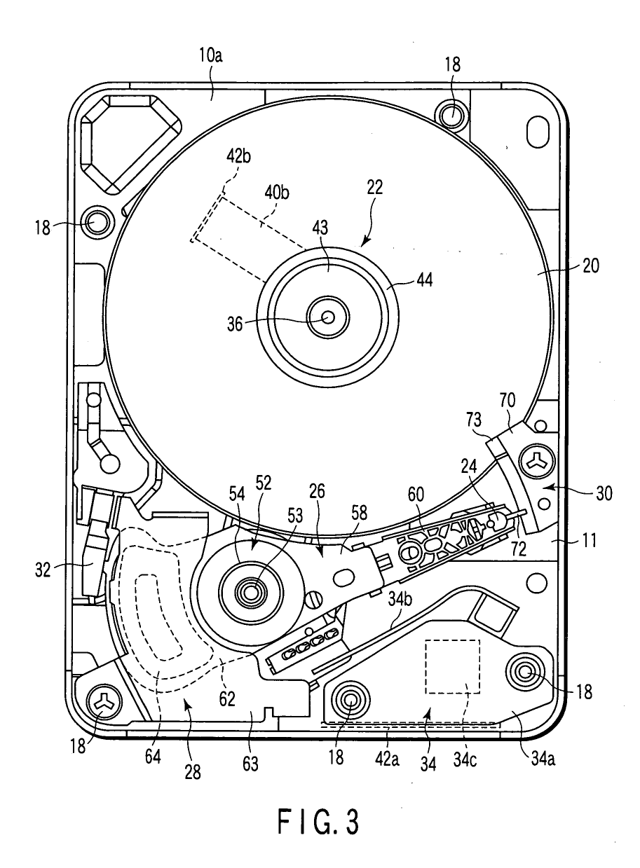

As shown in FIG. 3, the carriage 26 comprises an arm 58 extending from the hub 54, a suspension 60 in the form of an elongate plate extending from the distal end of the arm, and a support frame 62 extending from the hub 54 in the direction opposite from the arm. The magnetic head 24 is supported on an extended end of the suspension 60 by a gimbals portion (not shown). The head 24 is subjected to a predetermined head load that is directed toward a surface of the magnetic disk 20 by the spring force of the suspension 60. A voice coil 64 that constitutes the VCM 28 is integrally fixed to the support frame 62.

The VCM 28, which can rock the carriage 26 around the bearing assembly 52, includes a pair of yokes 63 and a magnet (not shown). The yokes 63 are fixed on the first shell 10a and opposed to each other with a gap between them. The magnet is fixed to the inner surface of one of the yokes and opposed to the voice coil 64. If the coil 64 is energized, the carriage 26 rocks between the retracted position shown in FIG. 3 and an operating position in which it is situated over the surface of the magnetic disk 20. Thereupon, the magnetic head 24 is positioned over a desired track of the disk 20. The solenoid latch 32 fixed to the first shell 10a latches the carriage 26 that is moved to the retracted position, thereby preventing the carriage 26 from moving from the retracted position to the operating position if the HDD is subjected to any external force such as shock.

The ramp load mechanism 30 includes a ramp member 70 and a tab 72. The ramp member 70 is fixed to the inner surface of the first shell 10a and opposed to the peripheral edge portion of the magnetic disk 20. The tab 72 extends from the distal end of the suspension 60 and serves as an engaging member. The ramp member 70 is formed by bending a plate material and has a ramp surface 73 that can be engaged with the tab 72. When the carriage 26 rocks from the inner peripheral portion of the magnetic disk 20 to the retracted position beside the outer periphery of the magnetic disk, the tab 72 engages the ramp surface 73 of the ramp member 70. Thereafter, the tab 72 is pulled up along a slope of the ramp surface, whereupon the magnetic head 24 is unloaded. When the carriage 26 rocks to the retracted position, the tab 72 is supported on the ramp surface 73 of the ramp member 70, and the magnetic head 24 is kept apart from the surface of the magnetic disk 20.

The board unit 34 has a body 34a formed of a flexible printed circuit board. The body 34a is fixed to the inner surface of a bottom wall of the first shell 10a. Electronic components, such as a head IC 34c, are mounted on the body 34a. The board unit 34 has a main flexible printed circuit board (main FPC) 34b that extends from the body 34a. An extended end of the main FPC 34b is connected to a portion near the bearing assembly 52 of the carriage 26 and further electrically connected to the magnetic head 24 by a cable (not shown) that is provided on the arm 58 and the suspension 60.

As shown in FIGS. 3, 4 and 6, the board unit 34 has a first flexible printed circuit board (first FPC) 40a that extends from the body 34a and serves as a first connection cable. The first FPC 40a is formed of a part of the FPC constituting the body 34a. The first FPC 40a is led out of the case 10 through a slit 42a in the bottom wall 11 and extends along the respective outer surfaces of the bottom wall and one side wall, that is, a side wall set up along one long side of the bottom wall in this case. The slit 42a through which the first FPC 40a is passed is hermetically sealed by a seal or the like. It may be adhesively bonded to the outer surface of the bottom wall 11.

A plurality of, e.g., eight, connection pads 45a are formed on an extended end of the first FPC 40a and exposed to the outside on a side wall of the case 10. The connection pads 45a are arranged at intervals in the longitudinal direction of the side wall. A cover layer (not shown) of, e.g., a resist is formed on a surface of the first FPC 40a and covers the area around the connection pads 45a. A liner plate 46a formed of, e.g., stainless steel or polyimide is pasted on the reverse surface of the extended end of the first FPC 40a.

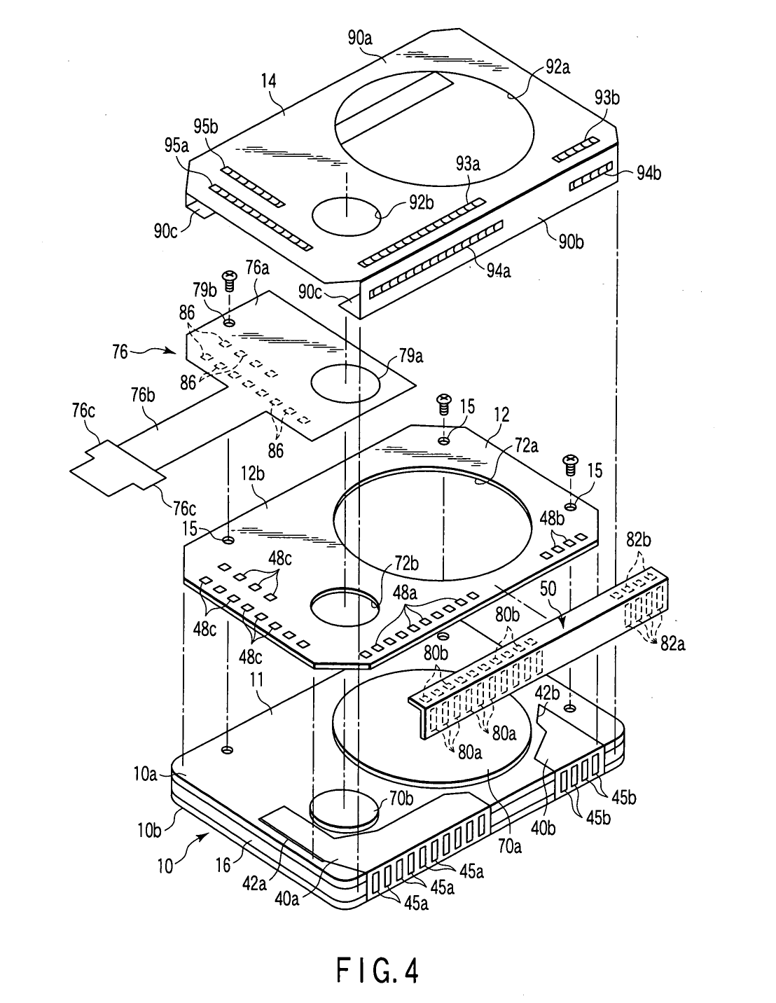

As shown in FIGS. 3 and 4, the spindle motor 22 is connected with a second flexible printed circuit board (second FPC) 40b that serves as a second connection cable. The second FPC 40b is led out of the case 10 through a slit 42b in the bottom wall 11 and extends along the respective outer surfaces of the bottom wall and one side wall, that is, a side wall on which the first FPC 40a is provided in this case. The slit 42b through which the second FPC 40b is passed is hermetically sealed by a seal or the like. It may be adhesively bonded to the outer surface of the bottom wall 11.

A plurality of, e.g., four, connection pads 45b are formed on the extended end of the second FPC 40b and exposed to the outside on the side wall of the case 10. A cover layer (not shown) of, e.g., a resist is formed on a surface of the second FPC 40b and covers the area around the connection pads 45b. A liner plate formed of, e.g., stainless steel or polyimide is pasted on the reverse surface of the extended end of the second FPC 40b.

As shown in FIGS. 2, 4 and 6, the control circuit board 12, a printed circuit board, is a rectangular structure that are substantially equal to the bottom wall 11 of the case 10 in length and width. The bottom wall 11 of the case 10 is formed with a circular protrusion 70a corresponding to the spindle motor 22 and a circular protrusion 70b corresponding to the bearing assembly 52. The control circuit board 12 is formed with circular openings 72a and 72b corresponding to the protrusions 70a and 70b, respectively. Through holes 15 for screws are formed individually at three corner portions of the circuit board 12. The four corner portions of the circuit board 12 are cut diagonally, e.g., at 45 degrees to each side, and form cut portions 77, individually.

The control circuit board 12 has a mounting surface 12a opposed to the bottom wall 11 of the case 10 and a non-mounting surface 12b situated opposite from the outer surface of the case. Electronic components are mounted on the mounting surface 12a, and connectors are omitted. The control circuit board 12 is mechanically and electrically connected to the mechanical section in the case without using a connector. First pads 48a and second pads 48b for connecting the first and second FPCs 40a and 40b are provided on the non-mounting surface 12b. The first pads 48a, which are as many as the connection pads 45a of the first FPC 40a, are arranged side by side along one side edge of the control circuit board 12. The second pads 48b, which are as many as the connection pads 45b of the second FPC 40b, are arranged side by side along the one side edge of the circuit board 12.

On the non-mounting surface 12b of the control circuit board 12, moreover, third pads 48c for connecting an interface FPC 76 (mentioned later) are provided on one end portion of the circuit board with respect to its longitudinal direction. The third pads 48c are arranged in two rows along a short side of the circuit board 12. A cover layer (not shown) of, e.g., polyimide is formed on the mounting surface 12a of the circuit board 12 and covers the areas around the first, second, and third pads 48a, 48b and 48c.

The control circuit board 12 constructed in this manner is lapped on the bottom wall 11 of the case 10 and fastened to the first shell 10a by screws. As this is done, the circuit board 12 is located in a manner such that its four sides are aligned or coincident individually with the four sides of the bottom wall 11. The protrusions 70a and 70b that are formed on the bottom wall 11 are located in the openings 72a and 72b, respectively, of the control circuit board 12.

The cut portions 77 at the corners of the control circuit board 12 are situated individually corresponding to the four corner portions of the bottom wall 11. Thus, the four corner portions of the bottom wall 11 are exposed to the outside without being covered by the circuit board 12. The corners of the case 10 that include the four exposed corner portions of the bottom wall 11 individually constitute holding portions 78 for holding the case without touching the circuit board 12.

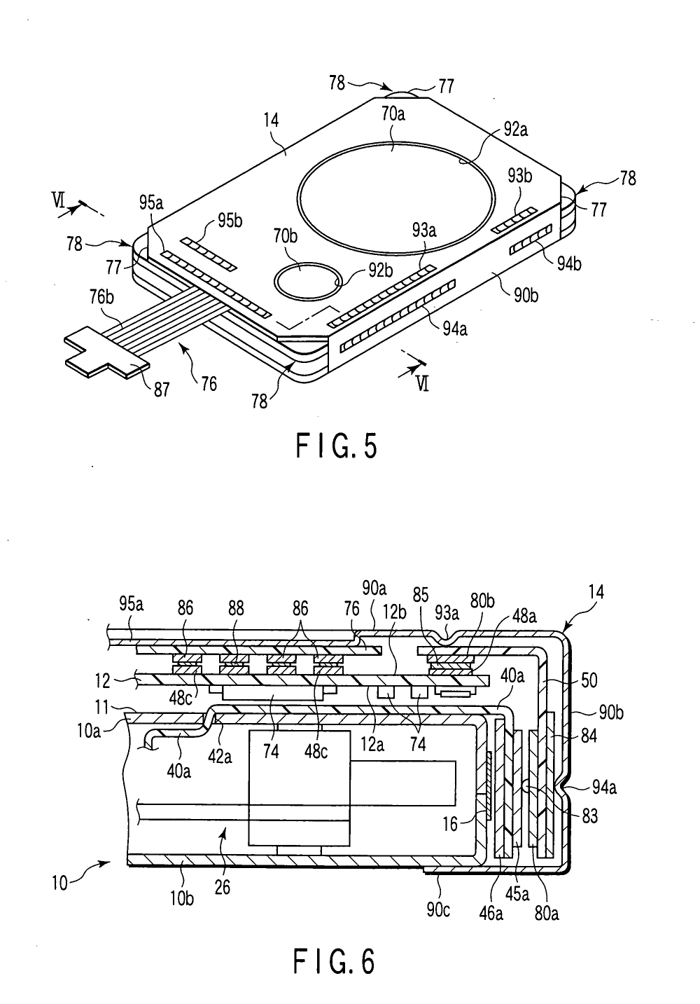

As shown in FIGS. 4 and 6, the control circuit board 12 and the first and second FPCs 40a and 40b are electrically connected to one another by a relay flexible printed circuit board (relay FPC) 50. The relay FPC 50 is in the form of an elongate belt that is bent having an L-shaped cross section. Connection pads 80a and connection pads 82a for connecting the first and second FPCs 40a and 40b are provided on the inner surface of one side wall of the relay FPC 50. The connection pads 80a, which are as many as the connection pads 45a of the first FPC 40a, are arranged side by side in the longitudinal direction of the relay FPC 50. The connection pads 82a, which are as many as the connection pads 45b of the second FPC 40b, are arranged side by side along the one side edge of the control circuit board 12. The connection pads 80a and 81a constitute a second connection pad. A liner plate 84 is fixed to the outer surface of one side wall of the relay FPC 50.

Connection pads 80b and connection pads 82b for connecting the control circuit board 12 are provided on the inner surface of the other side wall of the relay FPC 50. The connection pads 80b, which are as many as the first pads 48a of the circuit board 12, are arranged side by side in the longitudinal direction of the relay FPC 50. The connection pads 82b, which are as many as the second pads 48b of the circuit board 12, are arranged side by side along the one side edge of the relay FPC 50. The connection pads 80b and 81b constitute a first connection pad.

Each connection pad 80a is connected to its corresponding connection pad 80b through a conductor pattern (not shown). Each connection pad 82a is connected to its corresponding connection pad 82b through a conductor pattern (not shown).

The relay FPC 50 is lapped on the side edge portion of the control circuit board 12 and the first and second FPCs 40a and 40b, the connection pads 80a are in electrical contact with their corresponding connection pads 45a of the first FPC 40a, and the connection pads 82a are in electrical contact with their corresponding connection pads 45b of the second FPC 40b. For secure connection between the connection pads 80a and 45a and between the connection pads 82a and 45b, solder bumps 83 with a diameter of about 100 μm may be provided individually on the connection pads of either set, e.g., the connection pads 80a and 82a.

The connection pads 80b of the relay FPC 50 are in electrical contact with their corresponding first pads 48a of the control circuit board 12, and the connection pads 82b are in electrical contact with their corresponding second pads 48b of the circuit board 12. The relay FPC 50 may be joined in advance to the circuit board 12. According to the present embodiment, the connection pads 80b and 82b of the relay FPC 50 are joined electrically and mechanically to the first pads 48a and 48b of the circuit board 12 by an anisotropic conductive film (ACF) 85. Thus, the first and second FPCs 40a and 40b are electrically connected to the control circuit board 12 through the relay FPC 50.

As shown in FIGS. 1, 2, 4, 5 and 6, the control circuit board 12 is connected with an interface FPC 76 that serves as a connection cable for electrically connecting the HDD to an external device. The interface FPC 76 is pulled out through one short side of the circuit board 12, and connection terminals 75 are formed on its extended end.

The interface FPC 76 integrally has a proximal end portion 76a, a belt-shaped extending portion 76b, and a pair of grip portions 76c. The proximal end portion 76a is located on the control circuit board 12 so as to overlap the third pads 48c and extends in the array direction of the third pads. The extending portion 76b extends from the proximal end portion and has the connection terminals 75 on its extended end. The grip portions 76c extend individually on the opposite sides from the extending portion near the connection terminals. The proximal end portion 76a is formed with connection pads 86 that are situated corresponding to the third pads 48c, individually. The connection pads 86 are situated individually overlapping the third pads 48c of the circuit board 12 and electrically connected to the third pads. For secure connection between the connection pads 86 and the third pads 48c, solder bumps 88 may be provided individually on the connection pads of either set in advance. The proximal end portion 76a is formed with a circular opening 79a aligned with the opening 72b of the circuit board 12 and a through hole 79b aligned with one of the through holes 15 of the circuit board. The proximal end portion 76a is screwed together with the circuit board 12 to the case 10 and positioned with respect to the circuit board.

The connection terminals 75 on the extended end of the extending portion 76b are as many as the connection pads 86. They are in the form of an elongate rectangle each, individually extend in the extending direction of the extending portion 76b, and are arranged at intervals in a direction perpendicular to the extending direction. The connection terminals 75 are connected to their corresponding connection pads 86 by conductor lines that are formed on the proximal end portion 76a and the extending portion 76b.

A substantially T-shaped liner plate 87 is pasted on the respective reverse surfaces of the pair of grip portions 76c and the extended end portion of the extending portion 76b including the connection terminals 75. The liner plate 87 is formed of a nonconductive material, such as acrylic resin, and reinforces the extended end portion of the interface FPC 76. The extended end portion of the FPC 76 constructed in this manner is caused to engage connectors or the like of the external device, and the connection terminals 75 are electrically connected to terminals on the external device side, whereby the HDD can be connected to the external device.

As shown in FIGS. 1, 4, 5 and 6, the bottom cover 14 is attached to the case 10 and covers the control circuit board 12, the relay FPC 50, and the proximal end portion 76a of the interface FPC 76. The bottom cover 14 is formed by bending a thin metal plate. It integrally comprises a substantially rectangular body 90a, a pair of side walls 90b, and a pair of retaining portions 90c. The side walls 90b extend individually at right angles from the opposite long sides of the body 90a. The retaining portions 90c are formed by bending the respective extended end portions of the side walls at right angles and are opposed to the body 90a with gaps therebetween. The body 90a is formed having circular openings 92a and 92b that correspond in size to the openings 72a and 72b, respectively, of the control circuit board 12.

Two elongate belt-shaped projections 93a and 93b are formed near one side edge of the body 90a by drawing. They individually extend along the side edge and project toward the case 10. Two elongate belt-shaped projections 94a and 94b are formed on one of the side walls 90b by drawing. They individually extend along the side edge and project toward the case 10. Further, two elongate belt-shaped projections 95a and 95b are formed near one short side of the body 90a by drawing. They individually extend along the short side and project toward the case 10. The projections 93a, 93b, 94a, 94b, 95a and 95b are provided corresponding to the connection pads 80b, 82b, 80a and 82a and the connection pads 86 of the interface FPC 76, respectively.

As shown in FIGS. 1, 5 and 6, the bottom cover 14 is attached to the case 10 taking advantage of its own elasticity. Specifically, the bottom cover 14 is attached to the case 10 in a manner such that the body 90a and the retaining portions 90c elastically hold the case 10 from the opposite surface sides in its thickness direction and that the side walls 90b elastically hold the case 10 from the opposite sides in its width direction.

Thus, the body 90a of the bottom cover 14 faces the outer surface of the control circuit board 12 so as to be aligned with the circuit board, and presses the other side portion of the relay FPC 50 and the proximal end portion 76a of the interface FPC 76 against the circuit board 12. At the same time, the one side wall 90b of the bottom cover 14 presses the one side portion of the relay FPC 50 toward the first and second FPCs 40a and 40b. Thus, the connection pads 80a of the relay FPC 50 securely touch their corresponding connection pads 45a of the first FPC 40a, while the connection pads 82a are securely in contact with their corresponding connection pads 45b of the second FPC 40b. Further, the connection pads 80b and 82b of the relay FPC 50 are pressed by the body 90a of the bottom cover 14, whereby they are connected more securely to the first and second pads 48a and 48b of the control circuit board 12. Likewise, the connection pads 86 of the interface FPC 76 are pressed by the body 90a of the bottom cover 14, whereby they are brought securely into contact with the third pads 48c of the circuit board 12.

According to the present embodiment, the projections 94a, 94b, 93a, 93b, 95a and 95b that serve individually as pressing portions are formed on those parts of the bottom cover 14 which face the connection pads 80a, 82a, 80b and 82b of the relay FPC 50 and the connection pads 86 of the interface FPC 76. Accordingly, the pressure of contact can be increased by using these projections to press the connection pad portions of the relay FPC 50 and the interface FPC 76 toward the control circuit board 12 and the side wall of the case. Thus, the relay FPC 50 and the interface FPC 76 are connected securely.

In this manner, the head actuator located in the case 10 is electrically connected to the control circuit board 12 through the board unit 34, the first FPC 40a pulled out of the case through the board unit, and the relay FPC 50. Further, the spindle motor 22 in the case 10 is electrically connected to the circuit board 12 through the second FPC 40b, which is pulled out of the case, and the relay FPC 50.

According to the HDD constructed in this manner, the components arranged in the case are connected to the control circuit board 12 through the first and second FPCs and the relay FPC. Accordingly, there is no need of using any connectors, such as stacking connectors, compression connectors, etc., so that spaces for connector mounting can be reduced, and the case does not require any complicated shape for connector mounting. Thus, the HDD can be further reduced in size. Furthermore, the degree of freedom of design increases, that is, the design is facilitated, and the manufacturing costs can be reduced.

Since the bottom cover 14 is formed of metal or the like, the yield strength of the HDD against electromagnetic interference (EMI) can be enhanced.

Conventionally, in an HDD, an interface FPC for external device connection is connected and fixed to a control circuit board by using an ACF and constitutes a part of the control circuit board. If the destination of the HDD is changed, therefore, the entire control circuit board must be replaced with a new one.

According to the present embodiment, on the other hand, the interface FPC 76 is electrically connected to the control circuit board 12 by positioning using the screws or the opening 79a or by pressure welding with the bottom cover 14. Accordingly, the interface FPC 76 can be easily connected to the circuit board 12, so that only the FPC 76 can be replaced with ease. Thus, interface FPCs for a wide variety of external devices can be covered without increasing the manufacturing costs.

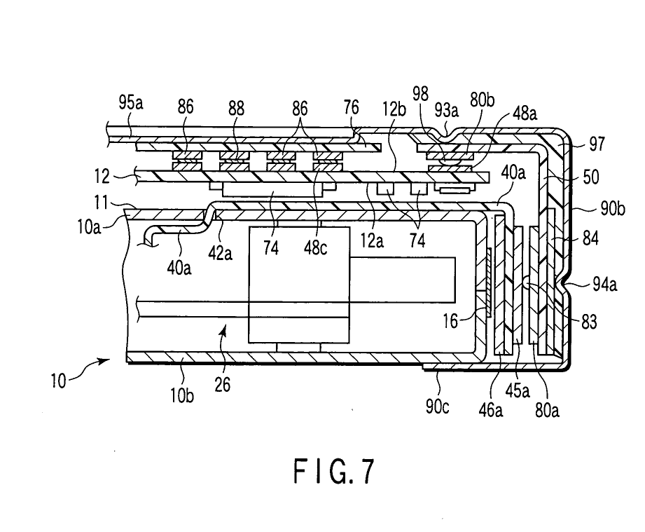

According to the embodiment described above, the relay FPC 50 is fixed and electrically connected in advance to the control circuit board 12 by using the ACF or the like. In an HDD according to a second embodiment of the invention shown in FIG. 7, a relay FPC 50 is previously bonded to the inner surface of a corner portion of a bottom cover 14 with an adhesive 97. In this case, solder bumps 83 are formed on connection pads 80a of the relay FPC 50 and/or connection pads 45a of a first FPC 40a and connection pads 82a of the relay FPC and/or connection pads 45b of a second FPC 40b, whereby connectivity between the pads is improved. Likewise, solder bumps 98 are formed on connection pads 80b of the relay FPC 50 and/or first pads 48a of a control circuit board 12 and connection pads 82b of the relay FPC and/or second pads 48b of the circuit board 12, whereby connectivity between the pads is improved.

Since the second embodiment shares other configurations with the foregoing embodiment, like reference numerals are used to designate like portions of these embodiments, and a detailed description of those portions is omitted. The same functions and effects of the foregoing embodiment can be also obtained from the second embodiment.

The present invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

The magnetic disk is not limited to one in number but more magnetic disks may be used, if necessary. The diameter of the magnetic disk is not limited to 0.85 inches but may be 1.8 or 2.5 inches.

In the embodiments described above, the first and second FPCs 40a and 40b are pulled out on the same side wall of the case and connected to the control circuit board through the common relay FPC 50. Alternatively, however, the first and second FPCs may be pulled out individually on the opposite side walls of the case and connected to the control circuit board through separate relay FPCs.

What is claimed is:

1. A disk device comprising:
a box-shaped case;
a disk-shaped recording medium located in the case;
a drive motor which is located in the case and supports and rotates the recording medium;
a head which performs information processing for the recording medium;
a head actuator which is provided in the case, supports the head for movement, and moves the head with respect to the recording medium;
a connection cable pulled out from the case onto an outer surface of the case;
a control circuit board provided opposite the outer surface of the case; and
a relay flexible printed circuit board which electrically connects the connection cable and the control circuit board.

2. The disk device according to claim 1, wherein the connection cable includes a first connection cable connected to the head actuator.

3. The disk device according to claim 1, wherein the connection cable includes a second connection cable connected to the drive motor.

4. The disk device according to claim 1, wherein the control circuit board has a mounting surface which is mounted with a plurality of electronic components and opposed to the outer surface of the case and a non-mounting surface which is provided with a plurality of pads and situated on the opposite side from the outer surface of the case, the connection cable has a plurality of connection pads exposed on the outer surface of the case, and the relay flexible printed circuit board has a first connection pad in contact with the control circuit board and a second connection pad in contact with the connection pads of the connection cable.

5. The disk device according to claim 1, further comprising a bottom cover which is attached to the case so as to cover the control circuit board and the relay flexible printed circuit board and presses the relay flexible printed circuit board against the control circuit board and the connection cable.

6. The disk device according to claim 5, wherein the case has a bottom wall opposed to the control circuit board and a plurality of side walls set up on the bottom wall, the connection cable extends along the bottom wall and the side walls of the case, and the connection pads of the connection cable are situated on the side walls.

7. The disk device according to claim 5, wherein the relay flexible printed circuit board is joined to the control circuit board.

8. The disk device according to claim 5, wherein the relay flexible printed circuit board is fixed to the bottom cover.

9. The disk device according to claim 1, further comprising an interface cable having a proximal end portion, which is held between the control circuit board and the bottom cover and electrically connected to the control circuit board, an extending portion extending from the proximal end portion toward the outside of the case, and a connection terminal connectable to an external device.

10. The disk device according to claim 1, wherein the case and the control circuit board are formed in a manner such that a longitudinal dimension thereof is about 32 mm, a transverse dimension thereof is about 24 mm, and a thickness including the case and the control circuit board ranges from about 3.3 to 5 mm.

11. The disk device according to claim 1, wherein the recording medium is formed having a diameter of 1 inch or less.

12. A disk device comprising:
a case;
a disk-shaped recording medium located in the case;
a head which performs information processing for the recording medium;
a mechanical section which is located in the case and drives the recording medium and the head; and
a control circuit board provided opposite the outer surface of the case, the control circuit board being mechanically and electrically connected to the mechanical section without using a connector.

13. The disk device according to claim 12, wherein the mechanical section comprises a spindle motor which is located in the case and supports and rotates the recording medium, and a head actuator which is provided in the case, supports the head for movement, and moves the head with respect to the recording medium.
